(19) United States
(12) Patent Application Publication
(10) Pub. No.: US 2022/0335448 A1
(43) Pub. Date: Oct. 20, 2022

(54) DYNAMICALLY GENERATING AND UPDATING A JOURNEY TIMELINE

(71) Applicant: Adobe Inc., San Jose, CA (US)

(72) Inventors: Saurabh Garg, New Delhi (IN); Mukul Lamba, Shimla (IN); Aditi Jain, Jaipur (IN); David Jocic, Begrade (RS)

(21) Appl. No.: 17/231,876

(22) Filed: Apr. 15, 2021

(51) Int. Cl. G06Q 30/02; H04L 29/08; G06F 16/901

(52) U.S. Cl. CPC G06Q 30/0201; G06Q 30/0204; H04L 67/22; H04L 67/1097; G06F 16/9024

(57) ABSTRACT

The present disclosure relates to systems, non-transitory computer-readable media, and methods for generating a dynamic journey graph representing various activities corresponding to a user-segment journey by displaying nodes with visual indicators that report portions of such users who experienced the various activities. In particular, in one or more embodiments, the disclosed systems receive datasets representing activities experienced by users from a user segment during a user-segment journey. The disclosed systems further determine different portions of users from the user segment that experienced particular activities, such as events or actions experienced by particular portions of the user segment. Based on determining different user portions that experienced different activities, the disclosed systems generate a journey graph including nodes with visual indicators reporting the different portions of users corresponding to particular activities.

### BACKGROUND

In recent years, data-analytics systems have been developed to track and report on user experiences as users progress along a path of interactions with a company or other entity. Along such an interaction path, users of a system often interact with companies, product providers, or other entities over a period leading up to, including, or after an experience and/or purchase. For example, users can interact with companies and/or product providers by calling over the phone, visiting a website, visiting a location in-person, or a combination of any such interactions. In addition to user-driven experiences, companies and providers can use computing systems to reach out to users and potential users via phone calls, emails, and other forms of communication.

To visualize a user-interaction path, some conventional data-analytics systems can generate a Sankey diagram or other graph that conventionally represents one or more patterns of user interactions along a user-interaction path and provide supplementary information about such user interactions on separate interfaces. Although conventional data-analytics systems can track user interactions and generate graphs for user-interaction paths, conventional systems often demonstrate a number of technical problems that hinder user navigation among graphical user interfaces, limit visualizations of a user-interaction path to a static model, and limit graphs of user-interaction paths to inflexible options and dimensions. For example, conventional systems often generate Sankey diagrams or other graphs of user-interaction paths (along with separate and supplementary information) about user interactions that foment inefficient user navigation among graphical user interfaces. To illustrate, some conventional systems require excessive interactions to switch between a graph and underlying data on separate graphical user interfaces. For instance, some conventional systems generate a static graph of user interaction paths separately from a graphical user interface with data about user interactions. Further, large datasets compound the tedious back-and-forth user navigation between graphical user interfaces because graphs may include a growing number of static nodes to represent such large datasets and have a corresponding (albeit separate and disconnected) data sheet. In such conventional data-analytics interfaces, users must switch back and forth between data sheets reporting on large datasets and graphs depicting many user interactions.

In addition to inefficient user navigation, many conventional data-analytics systems utilize a static model to generate Sankey diagrams or other graphs depicting a path of user interactions. To illustrate, many conventional systems utilize a static graph only showing user interactions—without visualization of time or variations among users along a user-interaction path. More specifically, conventional systems generate graphs without representing how particular users correspond to interactions represented by nodes (or other icons) within the graph. Accordingly, such conventional systems require additional user navigation away from the graph to determine data regarding users of the conventional systems.

Beyond a static model, conventional data-analytics systems often lack flexibility in presenting a user-interaction path. For instance, many conventional systems utilize inflexible templates that lack options for customization, such as pre-set nodes that cannot be adjusted or modified. Further, some conventional systems rigidly limit the type of visualizations of data to a single dimension, such as a static graph showing possible user interactions along a user-interaction path. To illustrate, conventional systems often include limited options for visualization types of interactions and data regarding the interactions. Additionally, as mentioned, many conventional systems do not provide any options for visualizations of users corresponding to the interactions.

### SUMMARY

This disclosure describes embodiments of systems, non-transitory computer-readable media, and methods that solve one or more of the foregoing problems or provide other benefits in the art. For example, the disclosed systems generate a dynamic journey graph that represents various activities experienced by users along a user-segment journey by displaying nodes with visual indicators that report portions of such users who experienced the various activities. To illustrate, in one or more embodiments, the disclosed systems receive datasets representing activities experienced by users from a user segment during a user-segment journey. The disclosed systems further determine different portions of users from the user segment that experienced particular activities, such as events or actions experienced by particular portions of the user segment. Based on determining different user portions that experienced different activities, the disclosed systems generate a journey graph including nodes with visual indicators reporting the different portions of users corresponding to particular activities.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description describes one or more embodiments of the disclosed systems, non-transitory computer-readable media, and methods with additional detail through the use of the accompanying drawings, as briefly described below.

FIG. 1 illustrates a diagram of an environment in which a journey graphing system can operate in accordance with one or more embodiments.

FIG. 2 illustrates an overview of a process for generating a journey graph including activity nodes with visual indicators reporting portions of users that experienced activities represented by the activity nodes in accordance with one or more embodiments.

FIG. 3 illustrates an example graphical user interface including a journey graph in accordance with one or more embodiments.

FIG. 4 illustrates an example flow of graphical user interfaces dynamically rendering a journey graph in accordance with one or more embodiments.

FIG. 5 illustrates a flow diagram for rendering and updating journey graphs in accordance with one or more embodiments.

FIGS. 6A-6B illustrates example graphical user interfaces of journey graphs including dynamic segmentation of users in accordance with one or more embodiments.

FIG. 7 illustrates an example journey graph including an activity node including graphical indicators representing sub-segments of users in accordance with one or more embodiments.

FIG. 8 illustrates a schematic diagram of a journey graphing system in accordance with one or more embodiments.

FIG. 9 illustrates a flowchart of a series of acts for generating a journey graph including activity nodes with visual indicators reporting portions of users that experienced activities represented by the activity nodes in accordance with one or more embodiments.

FIG. 10 illustrates a block diagram of an example computing device for implementing one or more embodiments of the present disclosure.

### DETAILED DESCRIPTION

This disclosure describes one or more embodiments of a journey graphing system that generates and dynamically updates a journey graph including various activity nodes that report portions of users that experienced various activities during a user-segment journey. To illustrate, in some embodiments, the journey graphing system receives activity datasets representing activities experienced by users from a user segment during a user-segment journey. Having received such activity datasets, the journey graphing system determines portions of users that experienced particular activities, such as users who experienced events and/or actions performed for users during the user-segment journey. The journey graphing system further maps particular portions of users to activity nodes. In some such cases, the journey graphing system determines percentages or other portions of a total user pool that experience an activity represented by a node. Based on those mappings, the journey graphing system generates a journey graph including activity nodes with visual indicators reporting portions of users that experienced various activities represented by the activity nodes.

As mentioned, in one or more embodiments, the journey graphing system receives activity datasets from a variety of sources. To illustrate, in some embodiments, the journey graphing system receives activity datasets from user devices, administrator devices, and/or third-party devices. In one or more embodiments, the activity datasets include event datasets corresponding to events carried out or otherwise experienced by users. For example, in some embodiments, activity datasets include action datasets representing actions performed for users from a user segment. Further, in one or more embodiments, activity datasets include event datasets representing events experienced by users (e.g., events carried out or executed by users) from the user segment. Additionally, in one or more embodiments, the activity datasets include condition datasets corresponding to users' satisfaction or failure to satisfy journey-entry conditions.

After receiving or accessing such datasets, in some embodiments, the journey graphing system determines portions of users that experienced certain activities—and have proceeded from one activity to another activity—during a user-segment journey. In one or more embodiments, for instance, the journey graphing system determines portions of users from a segment of users that experienced an activity as of a particular time period. To illustrate, in some embodiments, the journey graphing system continuously monitors and determines portions and/or subsets of users based on various activity datasets. In one or more embodiments, the journey graphing system tracks the actions, events, conditions, etc. performed and/or experienced by users to determine which users from the user segment have experienced particular activities as of a particular time and to determine the flow of users between activities.

After determining portions of users that experienced particular activities, in some embodiments, the journey graphing system maps the determined portions of users to nodes of a journey graph. To illustrate, in one or more embodiments, the journey graphing system determines nodes based on administrator creation of a journey graph. To illustrate, the journey graphing system maps a first portion of users that experienced an event to an event node. Further, the journey graphing system maps a second portion of users that experienced an action to an action node.

Having mapped particular portions of users from a user segment to activity nodes, the journey graphing system generates the journey graph. In some cases, the journey graph includes customized nodes selected and/or generated by an administrator device. As noted above, the journey graphing system generates each of the activity nodes including a visual indicator reporting the different portions of users that experienced different activities represented by the various activity nodes. More specifically, in one or more embodiments, the journey graphing system generates the activity nodes including visual indicators reporting a percentage of users for which an activity was successfully executed and/or identified. In some embodiments, the journey graphing system utilizes activity datasets to render the visual indicators within the journey graph. As explained further below and depicted in various figures, the journey graphing system can render the journey graph in real time (or near-real time) with dynamic reporting features based on selection of a reporting option.

As noted above, in one or more embodiments, the journey graphing system generates action nodes and event nodes as different types of activity nodes within a journey graph. In some embodiments, action nodes correspond to actions taken by a system or other entity for a user. For example, an action node can represent an email, an instant message, or a notification sent by a system or various other actions performed by a system. By contrast, in one or more embodiments, event nodes correspond to events completed and/or undertaken by a user of a user segment (e.g., for a system). For example, event nodes represent users checking in at a venue, presenting a ticket for entry, moving within a geofence, or other events undertaken by a user. In some embodiments, the journey graphing system detects actions and/or events from a user device and/or from administrator or third-party devices.

In addition to action nodes or event nodes, in some embodiments, the journey graphing system also generates or utilizes condition nodes in a journey graph. A condition node can represent a journey-entry condition that users from a user segment have satisfied (or not satisfied) for entering a user-segment journey. For instance, the journey graphing system can receive condition datasets corresponding to a variety of types of journey-entry conditions for users to begin or be included within a user-segment journey. Accordingly, the journey graphing system can receive and utilize data corresponding to condition nodes that correspond to a variety of condition types. For example, the journey graphing system can utilize condition nodes representing journey-entry conditions such as a membership status, progress toward a goal, pass or fail status, etc.

When generating or updating a journey graph, in one or more embodiments, the journey graphing system also generates edges between activity nodes representing users flowing between the activity nodes. As mentioned above, in one or more embodiments, the journey graphing system determines portions of users that performed different activities or moved from one activity to another represented by activity nodes. In some embodiments, for instance, the journey graphing system determines the portion of users that performed or experienced a particular activity represented by an activity node out of the total number of users in a user segment. Alternatively, the journey graphing system determines the portion of users that both successfully experienced a preceding activity represented by a preceding node and successfully experienced a subsequent activity represented by the subsequent node. In one or more embodiments, the journey graphing system generates edges between nodes with an edge thickness representing the determined portion of users or the users from the user segment targeted (or that have moved closer) to an activity represented by a subsequent node.

As suggested above, in some embodiments, the journey graphing system dynamically updates a journey graph. In one or more embodiments, the journey graphing system initializes a journey graph after creation in a pre-render state. Upon receiving user selection of a reporting option at an administrator device, the administrator device renders the journey graph by rendering activity nodes with visual indicators reporting in real (or near-real) time different portions of users that experienced different activities corresponding to the activity nodes. Additionally, in one or more embodiments, the journey graphing system provides continuous updates to various datasets to the administrator device and determines value changes corresponding to the various nodes. Accordingly, in some embodiments, the administrator device renders the value changes for nodes in a journey graph in real time or near-real time.

The journey graphing system provides many advantages and benefits over conventional systems and methods. For example, by consolidating real time reporting and journey data into a single graphical user interface, the journey graphing system improves navigational efficiency relative to conventional data-analytics systems. Specifically, the journey graphing system generates and provides a unified graphical user interface including a dynamic journey graph that comprises nodes including both journey information and user information corresponding to various activities along a user-segment journey. More specifically, in one or more embodiments, the journey graphing system generates nodes with visual indicators that dynamically report different portions of users that experienced different activities (e.g., actions, events) represented by activity nodes (e.g., action nodes, event nodes). As noted above, conventional data-analytics systems often display separate graphical user interfaces for static conventional graphs showing a user-interaction path and for statistics reporting user data for user interactions relevant to the user-interaction path. By contrast, the journey graphing system generates a journey map that represents the flow of users from a user segment (e.g., different portions of users) between activities represented by the activity nodes. Further, the journey graphing system reduces or eliminates excessive interactions required by conventional data-analytics systems to locate user data by providing reporting options and segmentation options within the unified graphical user interface.

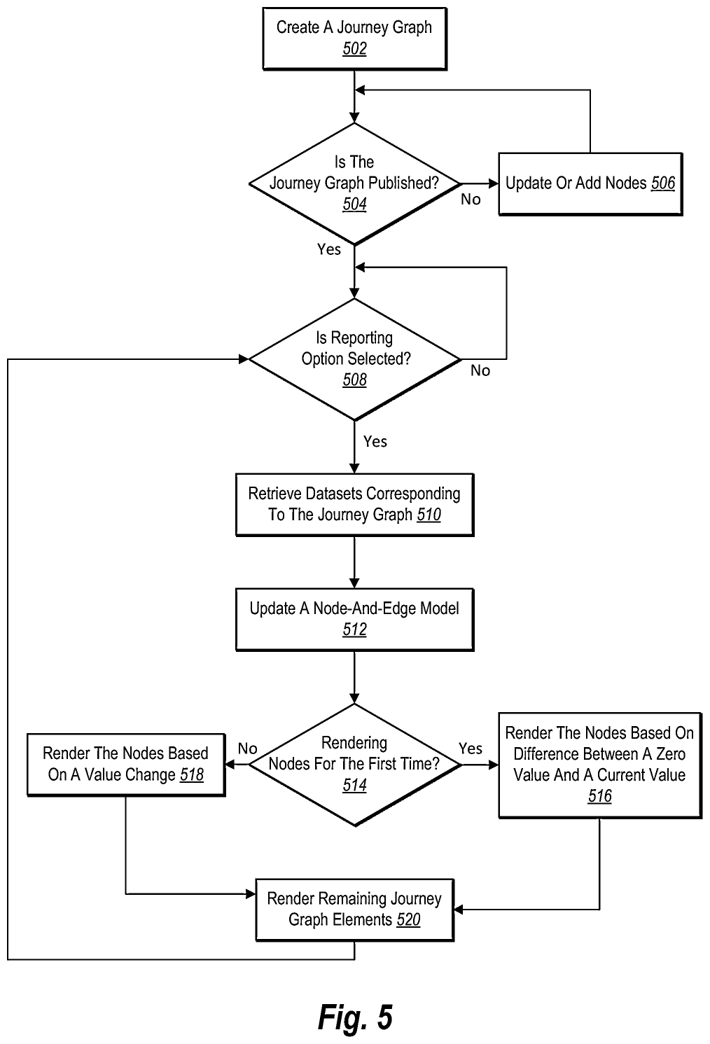

Beyond improved user navigation, in some embodiments, the journey graphing system improves computing efficiency over conventional data-analytics systems by utilizing an integrated node-and-edge model. Instead of utilizing multiple models for generating a separate and static journey graph, a separate Sankey diagram, and separate graphics showing statistics for particular users performing user interactions along a user-interaction path, the journey graphing system utilizes an integrated node-and-edge model to generate the disclosed journey graph comprising nodes with visual indicators that integrate reporting features. Accordingly, the journey graphing system conserves computing resources over conventional systems by reducing at least three separate computing models into a unified computing model. As explained further below with respect to FIG. 5, for example, the journey graphing system further conserves computing resources by updating such visual indicators reporting different user portions in the journey graph based on value changes between prior values and current values corresponding to activity nodes—rather than re-generating such visual indicators based on differences between zero values and current values corresponding to activity nodes.

In addition to improved navigation efficiency or improved algorithm efficiency, the journey graphing system improves efficiency relative to conventional systems by providing dynamic reporting of user data within journey graphs in real time or near-real time. More specifically, the journey graphing system updates the visual indicators of activity in real-time to indicate updated datasets. For example, the journey graphing system updates the visual indicator of an event node based on receiving an updated events dataset and determining an updated portion of users. Further, the journey graphing system updates the visual indicator of an action node based on receiving an updated action dataset and determining an updated portion of users. In one or more embodiments, the journey graphing system continuously updates the visual indicators based on a selection of a reporting option.

The journey graphing system also improves flexibility relative to conventional data-analytics systems by including various interaction options within the unified graphical user interface. To illustrate, the journey graphing system provides interactive options to view graphical representations of sub-segments from within portions of a user segment corresponding to activity nodes. More specifically, the journey graphing system provides options within the journey graph itself to view visual indicators corresponding to various types of user characteristics. For example, the journey graphing system can provide options for presenting visual indicators corresponding to user sub-segments for demographic information, user interactions, user device type, etc. Additionally, in some embodiments, the journey graphing system also adjusts and changes the journey graph by adding or deleting specific nodes as selected by an administrator device. Thus, the journey graphing system reduces or eliminates excessive interactions required by conventional systems to page back and forth to view such user information.

As illustrated by the foregoing discussion, the present disclosure utilizes a variety of terms to describe features and advantages of the journey graphing system. Additional detail is now provided regarding the meaning of such terms. For example, as used herein, the term “user-segment journey” refers to an organized set of activities experienced by some or all users of a user segment during interactions with an entity. To illustrate, a user-segment journey can include an ordered set of conditions, events, and/or actions encountered, performed, and/or experienced by a user from a user segment during a user experience with the products or services of a company, an organization, or another entity. Such conditions, events, and/or actions may be recorded or tracked by computing devices of an entity or the user.

Additionally, as used herein, the term “journey graph” refers to a graphical representation of user interactions during a user-segment journey. In particular, a journey graph can include a graphical representation of a user-segment journey including a node corresponding to each of a variety of activities in the user-segment journey. To illustrate, a journey graph can include activity nodes (e.g., event nodes, action nodes), condition nodes, wait nodes, end nodes, edges, percentage indicators, sub-segmentation options, etc.

Also, as used herein, the term “activity” refers to an interaction between a user of a user segment and one or more systems corresponding to an entity. In particular, the term activity can include a variety of actions or events during a user-segment journey as a user interacts with products or services through various computing devices. To illustrate, an activity can include an event, an action, a condition and/or other points of interaction for a user during a user-segment journey.

Additionally, as used herein, the term “event” refers to a user interaction experienced by a user during a user-segment journey. In some cases, an event includes an activity performed directly or indirectly by a user or the user's computing device during a user-segment journey. For example, an event can include a user interaction within a graphical user interface, entry into an amusement park or ride of an amusement park detected by a sensor or by a computing device, a location traveled to by a computing device as detected or indicated by a Global Positioning System (GPS) unit, Bluetooth interactions from a user's computing device, a location or movement indicted by Near Field Communication (NFC) antenna or coil or Radio-Frequency Identification (RFID) tag, etc.

Further, as used herein, the term “action” refers to an action performed for a user during a user-segment journey. In some cases, an action includes an activity performed directly or indirectly by an entity, an entity's system, or an entity's computing device for a user during a user-segment journey. For example, an action can include a computing system of an entity sending an email or other message to a user; modifying user data or status for a user; generating, modifying, or cancelling a user reservation for a user, etc.

Additionally, as used herein, the term “activity dataset” refers to various data and metadata corresponding to an activity or set of activities experienced by users from a user segment. For example, in some cases, an activity dataset includes an events dataset representing a set of events experienced by users from a user segment during a user-segment journey or an action dataset representing a set of actions performed for the users from the user segment during the user-segment journey. In one or more embodiments, an activity dataset includes data and metadata for a portion of users corresponding to an activity, including user identifiers, user characteristic data, data corresponding to user instances of the activity, etc.

Also, as used herein, the term “user segment” refers to a set of users corresponding to a common or shared attribute or characteristic. For example, a user segment can include a set of users corresponding to a common or shared journey or set of user interactions with respect to an entity (e.g., company, application, website, store). In one or more embodiments, a user segment can further include sub-segments of users based on a variety of criteria, including particular user characteristics.

Further, as used herein, the term “journey-entry condition” refers to an activity, a rule, and/or a characteristic that define entrance or inclusion within a user-segment journey. For example, a journey-entry condition can include a common user interaction or activity defining a user segment that begins or enters a journey with respect to an entity (e.g., company, application, web site, store).

Also, as used herein, the term “activity node” refers to a graphical-user-interface element for a connecting point at which an edge of a graph ends or edges of the graph intersect. To illustrate, an activity node can include a circular graphical-user-interface element at which edges of a journey graph end or intersect. In particular, the term node can include a portion of a journey graph corresponding to a user interaction with a system. To illustrate, a node can include a graphical representation corresponding to an activity (e.g., an event, action, condition) in a journey graph.

Additionally, as used herein, the term “visual indicator” refers to a graphical-user-interface element that graphically indicates a portion of users from a user segment that experienced an activity. In particular, a visual indicator can graphically indicate within or around an activity node (within a journey graph) a portion (e.g., percentage) of users from a user segment that experienced an activity represented by the activity node. To illustrate, a visual indicator can include a circumference indicator, pie chart, multiple line bars, collections of shapes, etc.

Further, as used herein, the term “edge” refers to a connection or vertices between nodes of a nodal graph. To illustrate, an edge can include a graphical line segment that connects nodes in a journey graph.

Additionally, as used herein, the term “reporting option” refers to a graphical-user-interface element that (upon selection or other user interaction by a computing device) causes a rendering or update of a journey graph with dynamic reporting features. In particular, a reporting option can include graphical-user-interface elements, such as a button, a toggle, a switch, etc., for initiating reporting features of visual indicators corresponding to activity nodes. To illustrate, in one or more embodiments, the journey graphing system renders and continuously updates a journey graph comprising activity nodes with visual indicators reporting in real (or near-real) time different portions of users that experienced different activities corresponding to the activity nodes—based on receiving user selection of a reporting option.

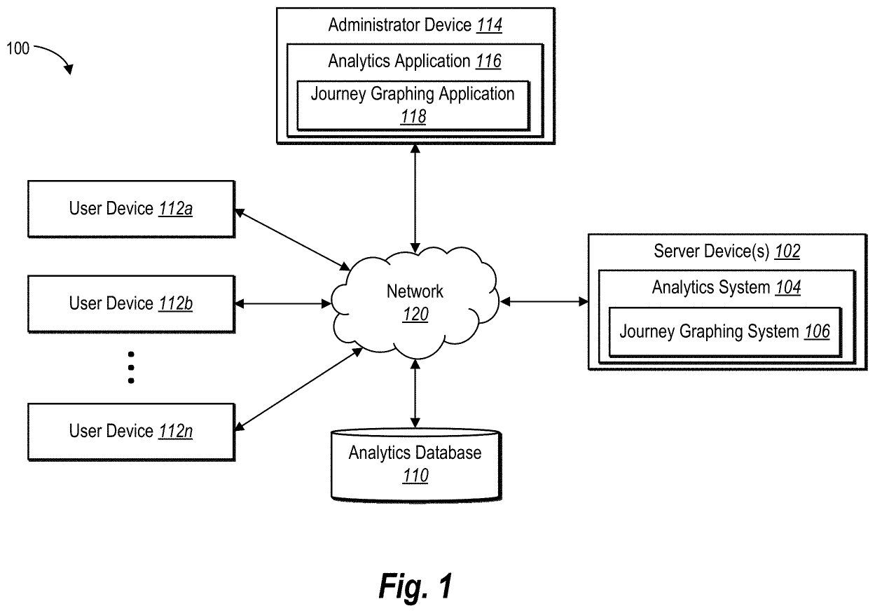

Additional detail regarding the journey graphing system will now be provided with reference to the figures. For example, FIG. 1 illustrates a schematic diagram of an example environment for implementing a journey graphing system 106 in accordance with one or more embodiments. More specifically, FIG. 1 illustrates a system 100 including server device(s) 102 including an analytics system 104 and a journey graphing system 106, an analytics database 110, user devices 112a, 112b, and 112n (collectively, the user devices 112a-112n), an administrator device 114 including an analytics application 116 and a journey graphing application 118, and a network 120.

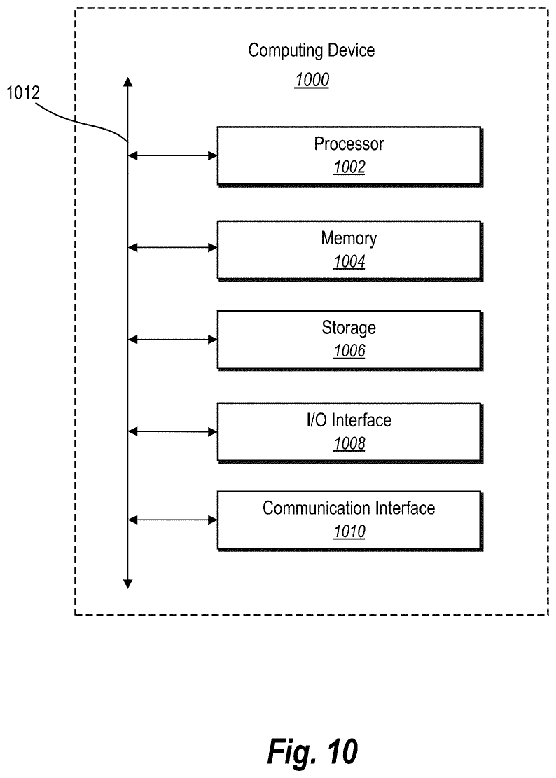

As shown in FIG. 1, the server device(s) 102, the user devices 112a-112n, and the administrator device 114 can communicate over the network 120, which may include one or multiple networks and may use one or more communication platforms or technologies suitable for transmitting data. In one or more embodiments, the network 120 includes the Internet. In addition, or as an alternative, the network 120 can include various other types of networks that use various communication technologies and protocols, as described in additional detail below with regard to FIG. 10.

As further shown in FIG. 1, the system 100 includes the server device(s) 102. As shown in FIG. 1, the server device(s) 102 can include the analytics system 104, which in turn can include the journey graphing system 106. The server device(s) 102 generate, track, store, process, receive, and transmit electronic data, such as activity datasets and/or journey graphs. For example, in one or more embodiments, the server device(s) 102 transmit activity datasets (and/or updates to activity datasets) to or from the user devices 112a-112n, the administrator device 114, the analytics database 110, and/or third-party devices, via the network 120.

As further shown in FIG. 1, the system 100 includes the analytics database 110. Though FIG. 1 illustrates the analytics database 110 as a separate entity, in one or more embodiments, the analytics database 110 is part of the analytics system 104 and/or the server(s) 102. In some embodiments, the analytics database 110 stores and manages analytics data, including activity datasets. In one or more embodiments, these activity datasets include events datasets, action datasets, and/or condition datasets. The analytics database 110 can receive analytics data from the user devices 112a-112n, the administrator device 114, and/or the server device(s) 102.

As mentioned, the system 100 also includes the user devices 112a-112n. The user devices 112a-112n can include a variety of computing devices, including a smartphone, a tablet, a smart television, a desktop computer, a laptop computer, a virtual reality device, an augmented reality device, or another computing device as described in relation to FIG. 10. The user devices 112a-112n can include multiple different client devices, each associated with a different user. The user devices 112a-112n can transmit various data to the server device(s) 102 and/or the administrator device 114. For example, the user devices 112a-112n can transmit user inputs, GPS data, NFC data, etc. via the network 120.

The system 100 also includes the administrator device 114. In one or more embodiments, the administrator device 114 includes the analytics application 116 and the journey graphing application 118. The administrator device can include a variety of computing devices, including a smartphone, a tablet, a smart television, a desktop computer, a laptop computer, a virtual reality device, an augmented reality device, or another computing device as described in relation to FIG. 10. Though FIG. 1 illustrates one administrator device 114, the system 100 can include multiple administrator devices. In some embodiments, the administrator device 114 renders journey graphs based on activity datasets received from the user devices 112a-112n, the analytics database 110, and/or the server device(s) 102.

In one or more embodiments, the administrator device 114 renders journey graphs utilizing the analytics application 116 and/or the journey graphing application 118. In some embodiments, the administrator device 114 utilizes the analytics application 116 to collect, manage, and analyze various datasets. Additionally, in one or more embodiments, the administrator device 114 utilizes the journey graphing application 118 to generate, render, and dynamically update journey graphs. The analytics application 116 and/or the journey graphing application 118 can include a native application and/or a web application on the administrator device 114. Although FIG. 1 depicts the journey graphing system 106 as part of the analytics system 104, in some embodiments, the journey graphing application 118 constitutes or comprises the journey graphing system 106, and the administrator device 114 accordingly executes the journey graphing system 106.

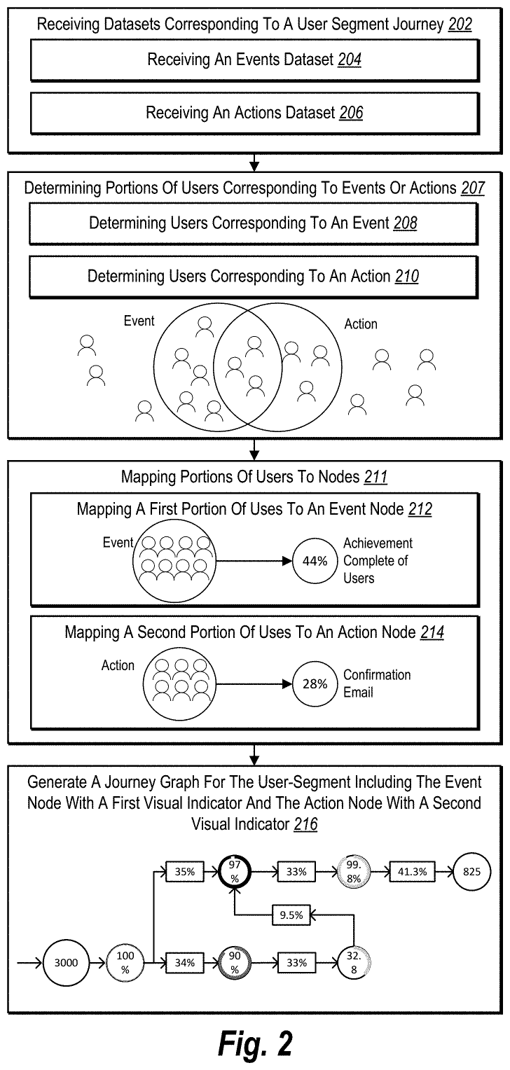

As mentioned above, in one or more embodiments, the journey graphing system 106 generates a journey graph including various activity nodes. FIG. 2 illustrates a flowchart for an overview of this process. To illustrate, as shown in FIG. 2, the journey graphing system 106 can perform an act 202 of receiving datasets corresponding to a user segment journey. In some embodiments, the journey graphing system 106 receives datasets from various sources, including user devices, third-party devices, administrator devices, etc.

As also shown in FIG. 2, the act 202 can include an act 204 of receiving an events dataset. In one or more embodiments, an events dataset includes data corresponding to events experienced by users from a user segment. In some cases, the journey graphing system 106 and/or a third-party system tracks, monitors, or records such events for users that are part of a user segment. Additionally, the act 202 can include an act 206 of receiving an actions dataset. In some embodiments, an actions dataset includes data corresponding to actions performed for users from the user segment. In some cases, a system or other entity performs acts represented by the actions dataset for the users.

Further, as shown in FIG. 2, the journey graphing system 106 can also perform an act 207 of determining portions of users corresponding to events or actions. To illustrate, in one or more embodiments, the journey graphing system 106 analyzes the datasets to identify users corresponding to particular activities. As shown in FIG. 2, the act 207 can include an act 208 of determining users corresponding to an event. For example, determining users corresponding to an event can include determining a percentage of users who made a purchase or interacted with a webpage—out of users who also experienced another activity or out of total users in a user segment. Additionally, the act 207 can include an act 210 of determining users corresponding to an action. For example, determining users corresponding an action can include determining a percentage of users that received an email or another message—out of users who also experienced another activity or out of total users in a user segment.

As illustrated in FIG. 2, the journey graphing system 106 can identify users corresponding to particular activities from among a group of users (e.g., users in a user-segment journey). As shown in FIG. 2, the portions of users corresponding to various activities can include one or more users in common. In the example shown for act 207, the portion of users corresponding to the event includes 44% of users (8 users), the portion of users corresponding to the action includes 28% of users (6 users), and the different portions of users have an overlap of three users in common. While FIG. 2 illustrates specific examples, the determined portions of users from a user segment can include any percentage, number, or other portion.

Additionally, as shown in FIG. 2, the journey graphing system 106 performs an act 211 of mapping portions of users to nodes. More specifically, the act 211 can include an act 212 of mapping a first portion of users to an event node representing a particular event experienced by the first portion of users. As shown in FIG. 2, the journey graphing system 106 maps the portion of users (e.g., the percentage of users or data indicators of the percentage of users) corresponding to the event to a particular event node corresponding to the event. In this particular example, the event node corresponds to a user achievement completed by certain users from a user segment and includes a percentage indicator of 44%.

As further shown in FIG. 2, the act 211 can include an act 214 of mapping a second portion of users to an action node. To illustrate, the journey graphing system 106 maps the portion of users (e.g., the percentage of users or data indicators of the percentage of users) corresponding to the action to an action node corresponding to the action. In this particular example, the action node corresponds to a confirmation email received by certain users from a user segment and includes a percentage indicator of 28%.

Based on the foregoing mappings, the journey graphing system 106 can also perform an act 216 of generating a journey graph for the user-segment journey including the event node with a first visual indicator and the action node with a second visual indicator. More specifically, the journey graphing system 106 generates a journey graph consistent with administrator input organizing various activity nodes into the journey graph representing a user-segment journey. In some embodiments, the journey graphing system 106 generates the journey graph based on the user-segment journey and receiving activity datasets (e.g., action datasets and event datasets) corresponding to activities within the user-segment journey.

As shown in FIG. 2, the journey graph includes a variety of activity nodes connected by edges. Further, the nodes include visual indicators that report portions of users (e.g., percentages of users) who successfully experienced the activity associated with the activity node. Additionally, the edges include percentage indicators corresponding to the portion of users (e.g., percentage of users) proceeding between activities corresponding to nodes relative to the total number of users in the user-segment journey.

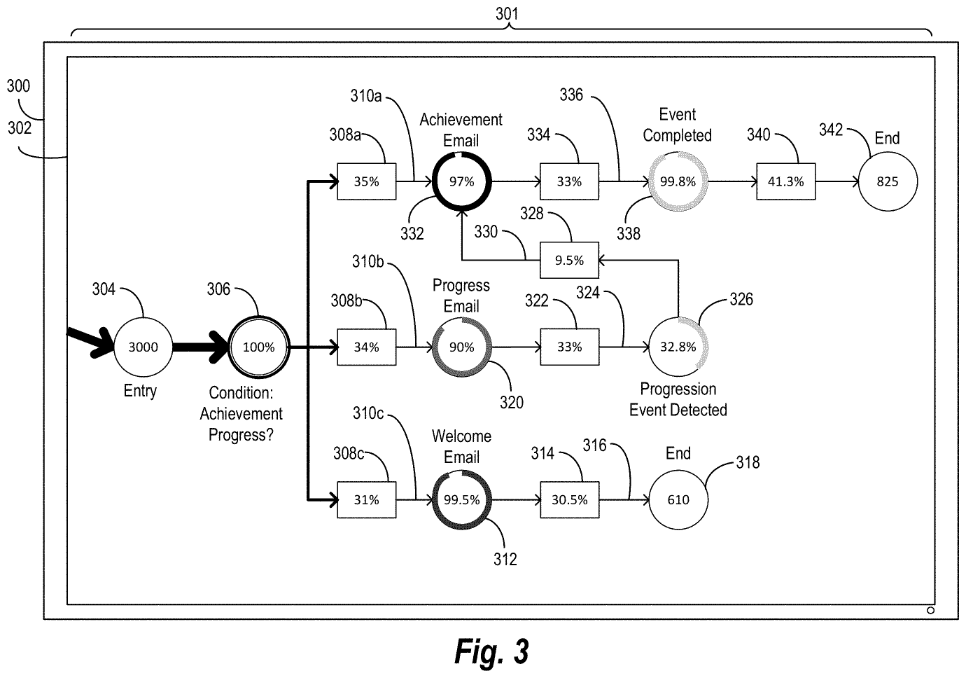

FIG. 3 illustrates an example graphical user interface including a journey graph. More specifically, FIG. 3 illustrates a computing device 300 displaying a graphical user interface 302 including a journey graph 301 with various activity nodes. As shown in FIG. 3, the journey graph 301 represents a variety of events, actions, and conditions that a user from a user segment may experience or otherwise trigger during a user-segment journey at a ticketed venue (e.g., an amusement park). However, the journey graphing system 106 can generate a variety of journey graphs reflecting a variety of user-segment journeys (e.g., at a hotel or resort, on a commercial airline flight).

In FIG. 3, the activity nodes include percentages and visual indicators of those percentages in a circumference indicator surrounding the nodes. In some cases, the circumference indicator is color coded or gray-scale coded to indicated whether an activity node represents a condition node, an action node, or an event node. As shown in this example, FIG. 3 illustrates percentages and visual indicators reflecting a portion of users for whom a corresponding activity was successfully determined, executed, and/or detected. However, as will be shown in various examples below, in one or more embodiments, activity nodes can include a variety of graph types, including pie chart, multiple line bars, shapes reflecting a percentage of users for the node, etc.

As further shown in FIG. 3, edges between activity nodes include percentage indicators and edge thicknesses corresponding to a percentage of users that experienced activities represented by adjacent nodes out of a total pool of users in the user-segment journey. However, the journey graphing system 106 can determine, utilize, and provide percentages for a journey graph that reflect a variety of meanings. For example, the journey graphing system 106 can provide visual indicators corresponding to an activity node reflecting a portion of users corresponding to a node relative to a total number of users in a user-segment journey.

As further shown in FIG. 3, the computing device 300 presents an entry node 304. FIG. 3 illustrates the entry node 304 including a total number of users entering the user-segment journey of the journey graph 301. In one or more embodiments, the computing device 300 receives an entry dataset including a number of users entering a user-segment journey from a third-party system, user devices, etc. In one or more embodiments, this entry dataset includes metadata corresponding to a trigger for entry into the user-segment journey. For example, the entry dataset can include data corresponding to the user action, such as GPS data, demographic data, etc. In addition, or in the alternative, the entry dataset can include metadata related to entry to a venue, such as a type of entry pass and/or a time of entry.

As also shown in FIG. 3, the computing device 300 presents a condition node 306. As illustrated in FIG. 3, the condition node 306 includes a full visual indicator and reads “100%.” Additionally, the condition node 306 is labelled “Condition: Achievement Progress?” As mentioned above, condition nodes correspond to a journey-entry condition reflecting an activity, a rule, and/or a characteristic that define entrance or inclusion within a user-segment journey. For the condition node 306, the computing device 300 receives a condition dataset corresponding to users encountering the journey-entry condition. Thus, the computing device 300 utilizes the condition dataset to determines user progress toward a digital achievement and determine portions of users that satisfy the journey-entry condition. More specifically, the computing device 300 determines whether each user has made full, partial, or no progress toward the digital achievement. In one or more embodiments, the computing device 300 determines a progress status of users from a user segment based on receiving the determination (e.g., from a third-party system).

As shown in FIG. 3, the computing device 300 presents edges 310a-310c including percentage indicators 308a-308c. The percentage indicators 308a-308c indicate different portions of users that satisfy a journey-entry condition for the condition node 306 have been targeted (or have moved closer) to an activity represented by another activity node connected to the edges 310a-310c. In particular, the edge 310a includes the percentage indicator 308a that reads “35%,” and has an edge thickness proportional to 35%—thereby indicating that a portion of users who satisfy the journey-entry condition for the condition node 306 have been targeted (or have moved closer) to experience an activity represented by an action node 332. Further, the edge 310b includes the percentage indicator 308b that reads “34%,” and has an edge thickness proportional to 34%—thereby indicating that another portion of users who satisfy the journey-entry condition for the condition node 306 have been targeted (or have moved closer) to experience an action represented by an action node 320. Additionally, the edge 310c includes the percentage indicator 308c that reads “31%,” and has an edge thickness proportional to 31%—thereby indicating that yet another portion of users who satisfy the journey-entry condition for the condition node 306 have been targeted (or have moved closer) to experience an activity represented by an action node 312.

As further shown in FIG. 3, the computing device 300 presents the journey graph 301 including a variety of action nodes and event nodes. As mentioned above, an action node can represent an action performed by an entity or an entity's system for a user during a user-segment journey. FIG. 3 illustrates the action nodes 312, 320, and 332. For example, an action can include an entity or an entity's computing system sending an email, sending a notification, updating a status for a user, etc. As further mentioned above, an event node can represent an event experienced by a user during a user-segment journey. For example, an event can include a user or a user's computing device checking in, entering a geofence, generating user input, etc. FIG. 3 illustrates event nodes 326 and 338.

As shown in FIG. 3, the journey graph 301 includes three branches of a user-segment journey along which different portions of users may travel or interact. The lower branch includes the action node 312 and the end node 318. The middle branch includes the action node 320 and the event node 326. The upper branch includes the action nodes 332, and the event node 338, and the end node 342.

Turning to the lower branch, the computing device 300 presents the action node 312 as part of the lower branch of the journey graph 301. The action node 312 is labelled “Welcome Email.” Additionally, the action node 312 includes the percentage text “99.5%” and a corresponding visual indicator (here, a circumference indicator) reflecting 99.5%—where both the percentage text and circumference indicator indicate that a portion of users who satisfy the journey-entry condition for the condition node 306 (and are selected or moved along activities for the lower branch) have successfully experienced an activity represented by an action node 312. In particular, both the percentage text and the circumference indicator indicate that, for users from the user segment that are targeted for the welcome email corresponding to the action node 312, an entity or an entity's system successfully performed the action for such users 99.5% of the time.

In one or more embodiments, the analytics system 104 or a third-party system provides an email or another message to users of the user segment as part of an event. A message sent as part of an event, including the welcome email of the action node 312, can include a variety of text and/or various multimedia selected by an administrator and/or the third-party system. For example, the welcome email can include information about various available digital achievements at a venue based on the date and/or time that the event is triggered.

As further shown in FIG. 3, the computing device 300 presents the edge 316 including the percentage indicator 314 as part of the journey graph 301. The percentage indicator 314 for the edge 316 reads “30.5%,” indicating that 30.5% of users in the user segment who experienced the action represented by the action node 312 have been targeted (or have moved closer) to an end of the user-segment journey. More specifically, as shown in FIG. 3, 30.5% of users in the user-segment journey proceed from experiencing the action represented by the action node 312 to an end represented by an end node 318.

As just indicated, the end node 318 is labelled “End.” Further, the end node 318 includes the number “610,” which indicates that 610 of the 3000 users that entered into the user-segment journey have proceeded to the end node 318 at the time of rendering the journey graph 301. Similarly, the computing device 300 presents the end node 342 labelled “End” and including the number “825,” indicating that 825 of the 3000 users that entered into the user-segment journey have proceeded to the end node 342 at the time of rendering.

In one or more embodiments, the computing device 300 determines users that have proceeded to an end node based on an end condition, such as leaving the venue. To illustrate, the computing device 300 can receive an end dataset corresponding to users relating to an end condition. Accordingly, the computing device 300 determines users who proceed to the end node based on the received end dataset. Additionally, or in the alternative, the computing device 300 automatically determines that a user proceeds to an end node after execution of a preceding node.

Turning to the middle branch, as also illustrated in FIG. 3, the computing device 300 presents the action node 320 as part of the middle branch of the journey graph 301. The action node 320 is labelled “Progress Email.” Additionally, the action node 320 includes the percentage text “90%,” and a corresponding visual indicator (here, a circumference indicator) reflecting 90%—where both the percentage text and circumference indicator indicate that another portion of users who satisfy the journey-entry condition for the condition node 306 (and are selected or moved along activities for the middle branch) have successfully experienced an activity represented by an action node 320. In particular, both the percentage text and the circumference indicator indicate that an entity or the entity's system successfully sent the progress email to 90% of users who were targeted for the progress email after satisfying the condition corresponding to the condition node 306.

As mentioned above, an action can include sending a variety of customized emails and other messages. Additionally, in one or more embodiments, an action message can include user-specific data from action datasets. For example, the progress email associated with the action node 320 can include a user-specific proportion of progress made toward the digital achievement.

As further shown in FIG. 3, the computing device 300 presents the event node 326. The event node 326 is labelled “Progression Event Detected,” indicating that the event node 326 corresponds to a determination that a user experienced an event progressing to a digital achievement. Additionally, the event node 326 includes the percentage text “32.8%” and a corresponding visual indicator (here, again, a circumference indicator) reflecting 32.8%—where both the percentage text and circumference indicator indicate that a portion of users who experienced the action represented by the action node 320 (and are selected or moved along activities for the middle branch) have successfully experienced an event represented by the event node 326. In particular, both the percentage text and the circumference indicator indicate that, for users from the user segment to whom a progress email was successfully sent, a progression event was experienced by 32.8% of such users at the time of rendering. To illustrate, the computing device 300 can utilize an events dataset corresponding to the event node 326 to determine progression.

As indicated above, the analytics system 104 can receive event datasets including data relating to a variety of progression events. For example, an event dataset can include user interactions with a graphical user interface on a user device. Additionally, or in the alternative, an event dataset can include various other user interactions, such as GPS, RFID, NFC, and/or Bluetooth interactions on a user device.

As also shown in FIG. 3, the computing device 300 presents the edge 330 including the percentage indicator 328 as part of the journey graph 301. The percentage indicator 328 for the edge 330 reads “9.5%,” indicating that 9.5% of the users in the user-segment who experienced the event represented by the event node 326 have been targeted (or have moved closer) to an action represented by the action node 332. As further depicted by FIG. 3, the edge 330 has an edge thickness reflecting the same 9.5%.

Turning to the upper branch, as further shown in FIG. 3, the computing device 300 presents the action node 332 as part of the upper branch of the journey graph 301. Both the edge 310a and the edge 330 connect to the action node 332. The action node 332 is labelled “Achievement Email,” includes the percentage text “97%,” and a corresponding visual indicator (here, a circumference indicator) reflecting 97%—where both the percentage text and circumference indicator indicate that a portion of users who merely satisfy the journey-entry condition for the condition node 306 or experienced the event represented by the event node 326 (and are selected or moved along activities for the upper branch) have successfully experienced an activity represented by the action node 332. In particular, both the percentage text and the circumference indicator indicate that, for the users from the user segment that are targeted for the achievement email, an entity or the entity's system successfully sent an achievement email to 97% of such users.

Additionally, as shown in FIG. 3, the computing device 300 presents the edge 336 including the percentage indicator 334 as part of the journey graph 301. The percentage indicator for the edge 336 reads “33%,” which indicates that 33% of the users in the user segment who experienced the action represented by the action node 332 have been targeted (or have moved closer) to an event represented by the event node 338. Additionally, the edge 336 has an edge thickness reflecting the same 33%.

As also shown in FIG. 3, the computing device 300 presents the event node 338 labelled “Event Completed.” The event node 338 includes the percentage text “99.8%” and a corresponding visual indicator (here, a circumference indicator) reflecting 99.8%—where both the percentage text and circumference indicator indicate that yet another portion of users who experienced the action represented by the action node 332 have successfully experienced an event represented by the event node 338. In particular, both the percentage text and the circumference indicator indicate that 99.8% of users that received the achievement email also completed the event represented by the event node 338. Additionally, as shown in FIG. 3, the computing device 300 presents the percentage indicator 340, indicating that 41.3% of users that experienced the event represented by the event node 338 are targeted (or have moved closer) to an end represented by the end node 342.

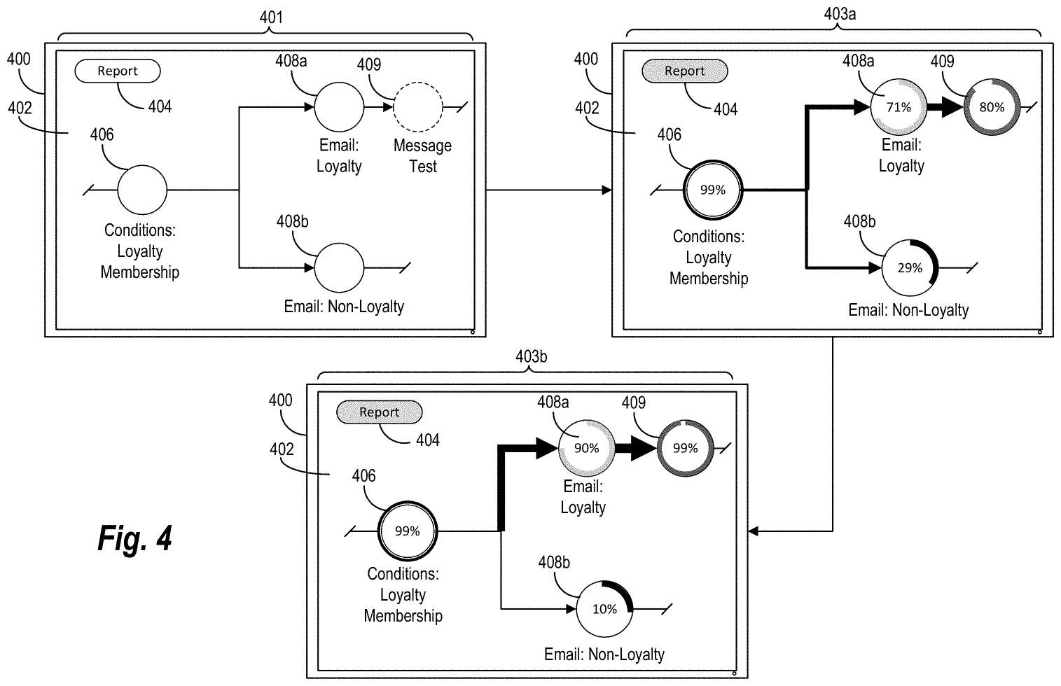

As mentioned above, in one or more embodiments, the journey graphing system 106 renders and updates a journey graph in real time or near-real time. FIG. 4 illustrates a computing device 400 displaying a journey graph 402 at three stages. More specifically, FIG. 4 illustrates a static-journey-graph rendering 401 before activating reporting features, a dynamic-journey-graph rendering 403a within a graphical user interface comprising visual indicators for activity nodes with dynamic reporting features, and a dynamic-journey-graph rendering 403b within an updated graphical user interface after dynamically updating in real or near-real time the visual indicators with dynamic reporting features.

As shown by the static-journey-graph rendering 401 in FIG. 4, the computing device 400 presents a reporting option 404. In some cases, the reporting option 404 is a button or a toggle including the text “Report.” In one or more embodiments, in response to detecting user input at the reporting option 404, the computing device 400 renders a dynamic journey graph as shown in the dynamic-journey-graph rendering 403a comprising activity nodes with visual indicators exhibiting dynamic reporting features and continuously updates the dynamic journey graph. Further, in one or more embodiments, based upon detecting a second selection at the reporting option 404, the computing device 400 returns to the static-journey-graph rendering 401 with the journey graph in a static state without visual indicators with dynamic reporting features.

As also shown by the static-journey-graph rendering 401 in FIG. 4, for instance, the computing device 400 presents a condition node 406 and action nodes 408a-408b. The condition node 406 corresponds to a journey-entry condition determining whether a user belongs to a loyalty membership program or not. By contrast, the action node 408a corresponds to sending a confirmation email for a loyalty member, while the action node 406b corresponds to sending a confirmation email for a non-loyalty member.

As indicated above, in some embodiments, the journey graphing system 104 adds (or removes) activity nodes to (or from) a journey graph based on user interactions with an administrator device. As shown by the static-journey-graph rendering 401 in FIG. 4, for instance, the computing device 400 adds a new activity node 409 in addition to the action nodes 408a and 408b. The new activity node 409 may include an action node or an event node.

In one or more embodiments, the journey graphing system 106 provides options to add various nodes to the journey graph. For example, the journey graphing system 106 provides options for node types, such as options to select an event node, an action node, a condition node, or an end node. Further, the journey graphing system 106 provides options for associating the node with a particular activity. For example, in one or more embodiments, the journey graphing system 106 provides a collapsible menu including a variety of categories of activity for selection of a particular activity by an administrator computing device.

As further shown by the static-journey-graph rendering 401 in FIG. 4, the computing device 400 initially maintains the journey graph 402 as static before rendering visual indicators with dynamic reporting features. To illustrate, as shown by the static-journey-graph rendering 401, the computing device 400 presents the journey graph 402 in static form based on an administrator-determined structure of the journey graph 402. In this initial stage, the computing device 400 does not render edge thicknesses or visual indicators or percentages within nodes because the reporting option 404 is unselected.

As shown by the dynamic-journey-graph rendering 403a in FIG. 4, in response to detecting user input at the reporting option 404, the computing device 400 renders the journey graph 402 in dynamic form including visual indicators, percentage markers, and edge thicknesses. For this initial dynamic rendering, the computing device 400 renders circumference indicators corresponding to the condition node 406, the action nodes 408a-408b, and the new activity node 409. To illustrate, the computing device 400 determines a portion of users from a user segment (e.g., in terms of percentage values) for each of the condition node 406, the action nodes 408a-408b, and the new activity node 409.

In some embodiments, the computing device 400 renders circumference indicators within the condition node 406, the action nodes 408a-408b, and the new activity node 409 increasing in size until each circumference indicator indicate the corresponding percentage shown within each of the condition node 406, the action nodes 408a-408b, and the new activity node 409. For example, the computing device 400 increases the length of the circumference indicators at predetermined increments and/or at a predetermined speed. That is, the computing device renders the nodes within the graphical user interface with the circumference indicators growing until they proportionally represent the determined percentage value shown in the dynamic-journey-graph rendering 403a.

As further shown by the dynamic-journey-graph rendering 403a in FIG. 4, in response to receiving user selection of the reporting option 404, the computing device 400 determines that the condition node 406 corresponds to a percentage value of 99%, the action node 408a corresponds to a percentage value of 71%, the new activity node 409 corresponds to a percentage value of 80%, and the action node 408b corresponds to a percentage value of 29%. Thus, the computing device 400 renders visual indicators (e.g., color-coded or gray-scale-coded circumference indicators) to reflect these percentage values.

In addition to such visual indicators, the computing device 400 renders edges within the journey graph 402 in dynamic form to indicate a percentage of users in a user segment targeted for an activity represented by a following activity node or to indicate a percentage of users in the user segment represented by the following activity node. In particular, the computing device 400 renders the edge thicknesses of the edges between the condition node 406 and the action nodes 408a-408b to reflect either (i) percentages of users from a user segment targeted for actions represented by the actions nodes 408a and 408b, respectively, or (ii) a percentages of users from the user segment that satisfy the journey-entry condition represented by the condition node 406 and that have experienced the actions represented by the actions nodes 408a and 408b, respectively. Similarly, the computing device 400 renders the edge thickness of the edge between the action node 408a and the new activity node 409 to reflect either (i) a percentage of users from a user segment targeted for an activity represented by the new activity node 409, respectively, or (ii) a percentage of users from the user segment that have experienced the action represented by the actions node 408a and experienced the activity represented by the new activity node 409.

As shown by the dynamic-journey-graph rendering 403b in FIG. 4, the computing device 400 dynamically updates the journey graph 402 based on the reporting option 404 remaining in a selected state. As shown by the dynamic-journey-graph rendering 403b, the computing device 400 determines updated percentage values for the condition node 406, the action nodes 408a-408b, and the new activity node 409. More specifically, the computing device 400 determines that the condition node 406 corresponds to an updated percentage value of 99%, the action node 408a corresponds to an updated percentage value of 90%, the new activity node 409 corresponds to a percentage value of 99%, and the action node 408b corresponds to an updated percentage value of 10%.

Thus, as shown by the transition between the dynamic-journey-graph rendering 403a and the dynamic-journey-graph rendering 403b, the computing device 400 determines a value change for each of the updated percentages. To illustrate, the computing device 400 determines that the condition node 406 corresponds to a value change of 0% (with zero change between 99% and 99%), the action node 408a corresponds to a value change of 19% (with a change from 90% to 71%), the new activity node 409 corresponds to a value change of 19% (with a change from 80% to 99%), and the action node 408b corresponds to a value change of −19% (with a change from 10% to 29%). The computing device 400 renders the value change to the percentages for the condition node 406, the action nodes 408a-408b, and the new activity node 409 as shown by the dynamic-journey-graph rendering 403b. For example, the computing device 400 modifies the length of the circumference indicators at predetermined increments and/or at a predetermined speed in each activity node in which corresponding percentage values have changed.

As further shown by the transition between the dynamic-journey-graph rendering 403a and the dynamic-journey-graph rendering 403b, in some embodiments, the computing device 400 further modifies the edge thicknesses of each corresponding edge. To illustrate, as shown in FIG. 4, the computing device 400 increases the edge thickness of the edge between the condition node 406 and the action node 408a. Further, the computing device 400 increases the edge thickness of the edge between the action node 408b and the new activity node 409. Finally, the computing device 400 decreases the edge thickness of the edge between the condition node 406 and the action node 408b.

Turning to FIG. 5, additional detail is provided with regard to rendering and updating journey graphs. More specifically, FIG. 5 illustrates a flowchart for a series of acts for publishing, rendering, and updating a journey graph in accordance with one or more embodiments. The series of acts in FIG. 5 may be carried out by the journey graphing system 106 via a single computing device and/or via multiple computing devices.

As shown in FIG. 5, the journey graphing system 106 can perform an act 502 of creating a journey graph. To illustrate, in one or more embodiments, the journey graphing system 106 can receive user input (e.g., administrator input via an administrator device) building a user-segment journey and journey graph. For example, the journey graphing system 106 can receive user selection of activity nodes and corresponding activities, edges, wait times, percentage reporting types, and/or a variety of other structures and options.

As further shown in FIG. 5, the journey graphing system 106 can perform an act 504 of determining whether the journey graph is published in static form. If the journey graphing system 106 determines that the journey graph is not published, the journey graphing system 106 can proceed to an act 506 of updating or adding nodes to the journey graph. That is, if the journey graph is unpublished, the journey graphing system 106 can continue to receive and implement modifications to the journey graph, such as adding or removing activity nodes as depicted in FIG. 4. As further shown in FIG. 5, the journey graphing system 106 continuously returns to the act 504 to monitor whether the journey graph is published or not.

If the journey graph is published in static form, the journey graphing system 106 can proceed to an act 508 for determining whether a reporting option is selected. If the reporting option is not selected, the journey graphing system 106 iteratively proceeds back to the act 508. Thus, the journey graphing system 106 continuously monitors selection of the reporting option.

However, if the journey graphing system 106 determines that the reporting option is selected, the journey graphing system 106 proceeds to an act 510 of retrieving datasets corresponding to the journey graph. To illustrate, the journey graphing system 106 retrieves the most up-to-date datasets corresponding to the journey graph. In one or more embodiments, retrieving the datasets includes retrieving particular datasets corresponding to particular activity nodes within the journey graph, such as by retrieving one or both of action datasets and event datasets. Further, in some embodiments, retrieving the datasets includes retrieving sub-segmentation data based on user characteristics and other metadata.

Upon retrieving the datasets, the journey graphing system 106 can proceed to an act 512 of updating an node-and-edge model. To illustrate, in some embodiments, the journey graphing system 106 organizes the datasets and then maps users to nodes and edges utilizing a node-and-edge model. In one or more embodiments, the node-and-edge model organizes nodes into classes and determines inputs and outputs for each node. Additionally, the node-and-edge model can associate each node with functionality for generating output (e.g., determining users that exit the node).

In some embodiments, the node-and-edge model further controls visual display of the journey graph, including nodes and edges. In particular, the node-and-edge model includes instructions for a computing device to render a journey graph. Further, in some embodiments, the node-and-edge model includes instructions for a computing device to update rendering of a journey graph. Thus, the journey graphing system 106 provides increased computing efficiency over conventional data-analysis systems that use separate models to generate a variety of separate graphs and charts. To illustrate, rather than utilizing separate and conventional computing models for a separate and static journey graph, a separate Sankey diagram, and separate graphics showing statistics for particular users performing user interactions along a user-interaction path, the journey graphing system 106 utilizes the node-and-edge model for generating a consolidated journey graph.

Upon updating the node-and-edge model, the journey graphing system 106 can proceed to an act 514 of determining whether the nodes are being rendered for the first time. If the nodes are being rendered for the first time, the journey graphing system 106 performs an act 516 of rendering the nodes based on a difference between a zero value and a current value. In particular, the journey graphing system 106 causes the rendering computing device to render any visual indicators associated with the journey graph (e.g., color circumference indicators) based on a difference between a zero value and a current value for an activity node to indicate a corresponding portion of users (e.g., percentage of users) within the activity node.

However, if the journey graphing system 106 determines that the nodes are not being rendered for the first time, the journey graphing system 106 can proceed to an act 518 of rendering a value change of the nodes. More specifically, the journey graphing system 106 determines a value change between the prior value for a node and an updated value for a node. Further, in one or more embodiments, the journey graphing system 106 causes the rendering computing device to render the value change for the node.

For example, at a first time, an action node corresponds to a portion of 500 users. At an updated time, the action node corresponds to an updated portion of 600 users. Thus, the journey graphing system 106 determines that a value change of 100 (600-500). Accordingly, the journey graphing system 106 can provide the value change of 100 to a rendering computing device to update the visual indicators within the journey graph.

Regardless of whether the journey graphing system 106 performs the act 516 or the act 518, as shown in FIG. 5, the journey graphing system 106 can proceed to an act 520 of rendering remaining journey graph elements. More specifically, in one or more embodiments, the journey graphing system 106 can cause a rendering computing device to render dynamic-journey-graph elements. More specifically, the rendering computing device can render edges with corresponding edge thicknesses, wait times, sub-segments, etc. As indicated above, FIGS. 3 and 4 depict examples of such dynamic-journey-graph elements.

As further shown in FIG. 5, in some cases, the journey graphing system 106 proceeds from the act 520 back to the act 508 to dynamically update the journey graph. Accordingly, the journey graphing system 106 can continuously monitor datasets corresponding to the journey graph and dynamically update the journey graph based on changes in real time or near-real time. In one or more embodiments, the journey graphing system 106 iteratively performs acts 508-520 every n seconds, with n set by an administrator or by default (e.g., every 1, 3, 5, or 10 seconds).

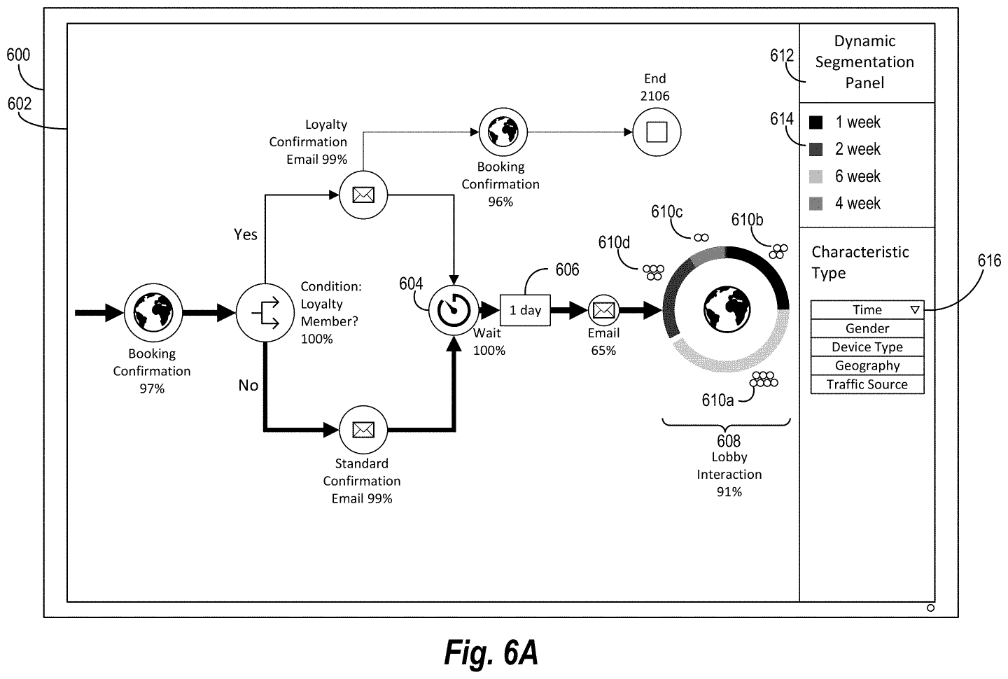

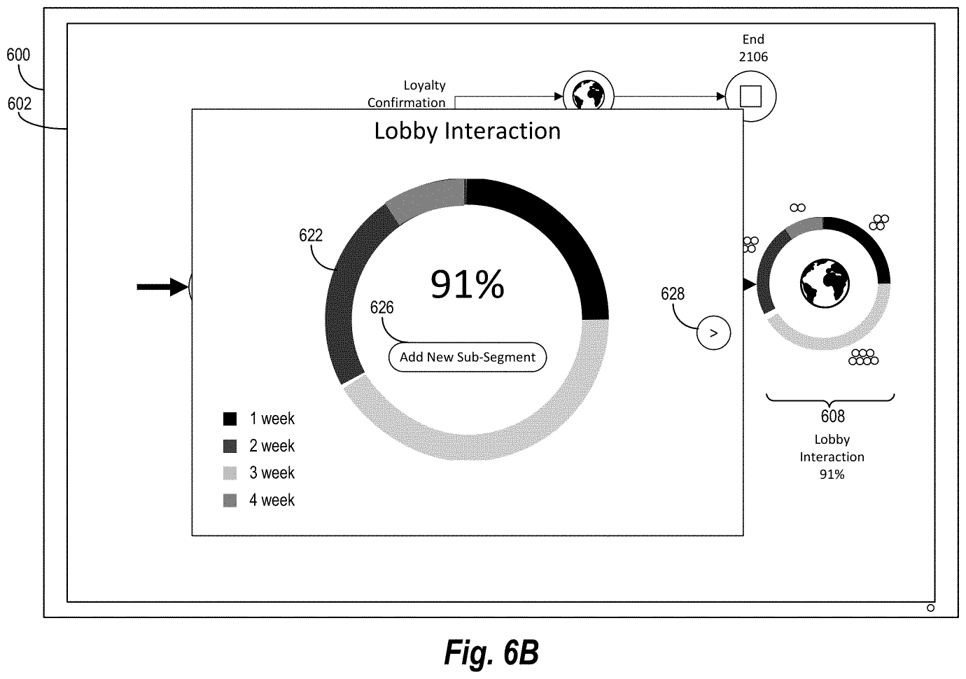

As discussed above, in one or more embodiments, the journey graphing system 106 dynamically provides sub-segmentation data within a journey graph. FIGS. 6A and 6B illustrate example graphical user interfaces for providing sub-segmentation data within a journey graph rendered within a graphical user interface. To illustrate, the journey graphing system 106 can provide graphical indicators corresponding to different sub-segments of users having various user characteristics in various locations within or alongside a journey graph. For example, as shown in FIG. 6A, the journey graphing system 106 can provide graphical indicators for user characteristics surrounding a node and/or in a side panel. Additionally, or in the alternative, as shown in FIG. 6B, the journey graphing system 106 can provide graphical indicators for user characteristics in an overlay.

As just indicated, FIG. 6A illustrates a computing device 600 displaying a graphical user interface 602 with various nodes. As shown in FIG. 6A, the computing device 600 presents a wait node 604. In one or more embodiments, a wait node corresponds to a predetermined wait time between activities corresponding to nodes. That is, based on encountering the wait node 604, the journey graph implements a time delay 606 before proceeding to the next activity corresponding to the next node in a user-segment journey. To illustrate, for the wait node 604, the journey graphing system 106 implements a time delay of one day before proceeding to send the email associated with the following action node.

FIG. 6A also illustrates an activity node 608 that the computing device 600 renders with a breakdown of sub-segments from a particular portion of users corresponding to the activity node 608. As shown in FIG. 6A, the activity node 608 includes sub-segment indicators 610a-610d. In some cases, the activity node 608 is an event node corresponding to an event for interaction at a hotel lobby. To illustrate, such an interaction may include user device interaction indicated by GPS, NFC, or Bluetooth data, etc. Additionally, or in the alternative, the user interaction at the lobby can include data received from a third-party system (e.g., regarding check-in or check-out).

In one or more embodiments, the computing device 600 presents the sub-segment indicators 610a-610d in response to user selection of the activity node 608. In some embodiments, the sub-segment indicators 610a-610d indicate users corresponding to the activity node 608 included in various sub-segments of a portion of users. As suggested FIG. 6A, the sub-segment indicators 610a-610d include corresponding and partitioned colors (as indicated along a grey scale) on a circumference indicator and hexagons showing a particular sub-segment of users.

Further, as shown in FIG. 6A the computing device 600 also presents a dynamic segmentation panel 612. The dynamic segmentation panel 612 includes a key 614 for the particular colors partitioned within the circumference indicator corresponding to the sub-segment indicators 610a-610d for the activity node 608. More specifically, the key 614 shows that different color shades (or grey-scale shades) on the circumference indicator correspond to different delay times of 1 week, 2 weeks, 4 weeks, or 6 weeks.

As just indicated by the sub-segment indicators 610a-610d for the activity node 608, in one or more embodiments, the journey graphing system 106 can receive datasets including data corresponding to time elapsed between activities. As shown in FIG. 6A, in some embodiments, the journey graphing system 106 determines sub-segments corresponding to various time elapsed between activities represented by activity nodes. To illustrate, the journey graphing system 106 determines time elapsed between a preceding activity (e.g., a preceding event or a preceding action) and a following activity (e.g., a following event or following action). Further, the journey graphing system 106 can determine sub-segments of users by grouping the users based on the determined time elapsed. Accordingly, in one or more embodiments, the journey graphing system 106 generates graphical indicators corresponding to these various sub-segments, such as those included in the key 614.

As further shown in FIG. 6A, the dynamic segmentation panel 612 includes a characteristic selection menu 616. The characteristic selection menu 616 includes various sub-segmentation options available for the selected activity node 608. For example, as shown in FIG. 6A, the characteristic selection menu 616 includes options to view or render sub-segments based on various user characteristics, such as gender, device type, geography, and traffic source. But any suitable user characteristic may be used as a basis for a sub-segment of users corresponding to an activity node.

As mentioned, the journey graphing system 106 can also provide data for sub-segmentation of users in an overlay. FIG. 6B illustrates the computing device 600 providing such an overlay. More specifically, FIG. 6B illustrates a circumference indicator 622 and corresponding key in an overlay on top of the graphical user interface 602.

Additionally, in one or more embodiments, the computing device 600 presents an additional sub-segmentation option 626. In some embodiments, in response to detecting user input at the additional sub-segmentation option 626, the computing device 600 provides options for rendering additional (or alternate) circumference indicators reflecting user characteristics of additional or different sub-segments of users corresponding to the activity node 608.

Further, as shown in FIG. 6B, the computing device 600 presents a page-through option 628. In one or more embodiments, in response to detecting user interaction at the page-through option 628, the computing device 600 provides sub-segmentation information for a subsequent node in a journey graph. Thus, the computing device 600 can efficiently provide sub-segmentation visualization for various nodes in a journey graph.

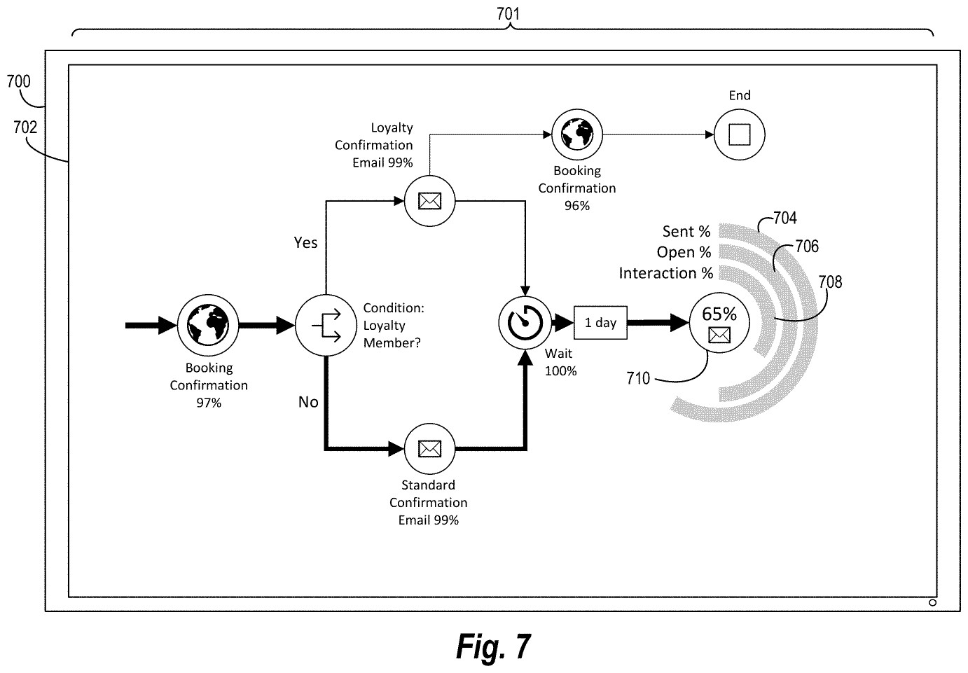

As also mentioned above, the journey graphing system 106 can determine and provide data for sub-segmentation of users based on user interaction corresponding to a particular node. FIG. 7 illustrates a computing device 700 presenting a journey graph 701 within a graphical user interface 702. More specifically, FIG. 7 illustrates an example visualization of sub-segmentation for an action node 710 corresponding to an email.

In one or more embodiments, the journey graphing system 106 determines sub-segments of users from among a portion of users corresponding to a particular node. More specifically, the journey graphing system 106 can generate a journey graph by generating graphical indicators (e.g., circumference indicators, pie charts, line bars, etc.) representing sub-segments of users having various interaction types corresponding to a node. To illustrate, the graphical indicators can represent sub-segments of users performing different user actions in response to a system action. Additionally, or in the alternative, the graphical indicators can represent segments of users performing variations of an event corresponding to an event node.

As shown in FIG. 7, the computing device 600 presents circumference line bars surrounding the action node 710. More specifically, the computing device 600 presents a sent bar 704, an open bar 706, and an interaction bar 708 partially surrounding the action node 710. The sent bar 704 corresponds to a sub-segment of users that were successfully sent the email. Further, the open bar 706 corresponds to a sub-segment of users that opened the email. Additionally, the interaction bar 708 corresponds to a sub-segment of users that performed a particular interaction with the email (e.g., selected a link in the email, completed a survey as prompted in the email).

Additionally, the journey graphing system 106 can determine and provide segmentation data for a variety of interaction types. For example, the journey graphing system 106 can determine sub-segments for types of user interaction during an event, such as a type of entry pass presented by a user's computing device at entry to a venue, a type of device interaction detected by the system at a checkpoint, a message type sent by a user's computing device corresponding to a user inquiry, etc. Further, the journey graphing system 106 can determine a variety of types of user interaction with or response to a system-generated action. For example, the journey graphing system 106 can determine a payment type completed in response to a prompt, a membership type generated based on a sent message, etc.

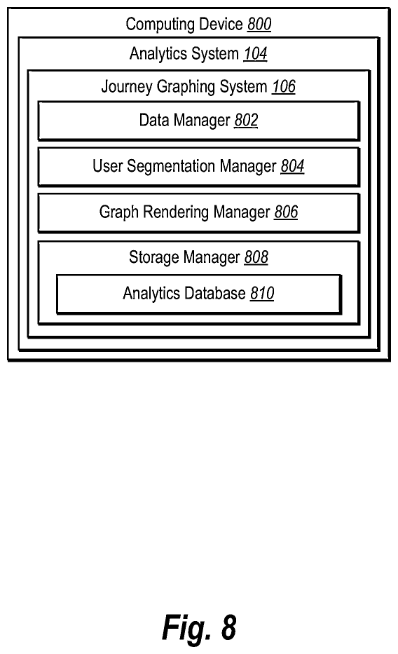

Looking now to FIG. 8, additional detail will be provided regarding components and capabilities of the journey graphing system 106. Specifically, FIG. 8 illustrates an example schematic diagram of the journey graphing system 106 on an example computing device 800 (e.g., one or more of the server device(s) 102, the user device(s) 112a-112n, and/or the administrator device 114). As shown in FIG. 8, the journey graphing system 106 includes a data manager 802, a user segmentation manager 804, a graph rendering manager 806, and a storage manager 808 including an analytics database 810.

As just mentioned, the journey graphing system 106 includes the data manager 802. In particular, the data manager 802 manages, maintains, generates, identifies, accesses, organizes, parses, or otherwise utilizes various data (e.g., activity datasets). For example, the data manager 802 manages various datasets for various types of user interactions included in a user-segment journey. In one or more embodiments, the data manager 802 receives datasets from a variety of sources, including administrator devices, user devices, and/or third-party devices.

The journey graphing system 106 also includes the user segmentation manager 804. In one or more embodiments, the user segmentation manager 804 determines and manages user segments, portions of users, and/or user sub-segments. In one or more embodiments, the user segmentation manager 804 receives user segments, portions of users, and/or user sub-segments from various sources, including administrator devices, user devices, and/or third-party devices. In addition, or in the alternative, in some embodiments, the user segmentation manager determines user segments, portions of users, and/or user sub-segments based on received activity datasets.

Further, the journey graphing system 106 includes the graph rendering manager 806. In one or more embodiments, the graph rendering manager 806 generates journey graphs representing user-segment journeys. Further, in some embodiments the graph rendering manager 806 renders the journey graphs in real-time based on receiving an indication of a user interaction (e.g., from an administrator device) at a reporting option. Additionally, the graph rendering manager 806 can update the journey graph in real-time based on continually receiving updated data (e.g., activity datasets).

Additionally, the journey graphing system 106 includes the storage manager 808, including an analytics database 810. In one or more embodiments, the storage manager 808 operates in conjunction with the analytics database 810 that store various data such as the activity datasets and/or models described herein. The storage manager 808 (e.g., via a non-transitory computer memory/one or more memory devices) stores and maintain data associated with user interactions and generating journey graphs (e.g., within the analytic database 810).

In one or more embodiments, each of the components of the journey graphing system 106 are in communication with one another using any suitable communication technologies. Additionally, the components of the journey graphing system 106 is in communication with one or more other devices including one or more client devices described above. It will be recognized that although the components of the journey graphing system 106 are shown to be separate in FIG. 8, any of the subcomponents may be combined into fewer components, such as into a single component, or divided into more components as may serve a particular implementation. Furthermore, although the components of FIG. 8 are described in connection with the journey graphing system 106, at least some of the components for performing operations in conjunction with the journey graphing system 106 described herein may be implemented on other devices within the environment.

The components of the journey graphing system 106 can include software, hardware, or both. For example, the components of the journey graphing system 106 can include one or more instructions stored on a computer-readable storage medium and executable by processors of one or more computing devices (e.g., the computing device 800). When executed by the one or more processors, the computer-executable instructions of the journey graphing system 106 can cause the computing device 800 to perform the methods described herein. Alternatively, the components of the journey graphing system 106 can comprise hardware, such as a special purpose processing device to perform a certain function or group of functions. Additionally, or alternatively, the components of the journey graphing system 106 can include a combination of computer-executable instructions and hardware.

Furthermore, the components of the journey graphing system performing the functions described herein may, for example, be implemented as part of a stand-alone application, as a module of an application, as a plug-in for applications including content management applications, as a library function or functions that may be called by other applications, and/or as a cloud-computing model. Thus, the components of the causality-visualization system 102 may be implemented as part of a stand-alone application on a personal computing device or a mobile device. Alternatively, or additionally, the components of the causality-visualization system 106 may be implemented in any application that allows creation and delivery of marketing content to users, including, but not limited to, applications in ADOBE MARKETING CLOUD, such as ADOBE CAMPAIGN, ADOBE EXPERIENCE CLOUD, and ADOBE ANALYTICS. “ADOBE,” “EXPERIENCE CLOUD,” “MARKETING CLOUD,” “CAMPAIGN,” and “ANALYTICS” are trademarks of Adobe Inc. in the United States and/or other countries.

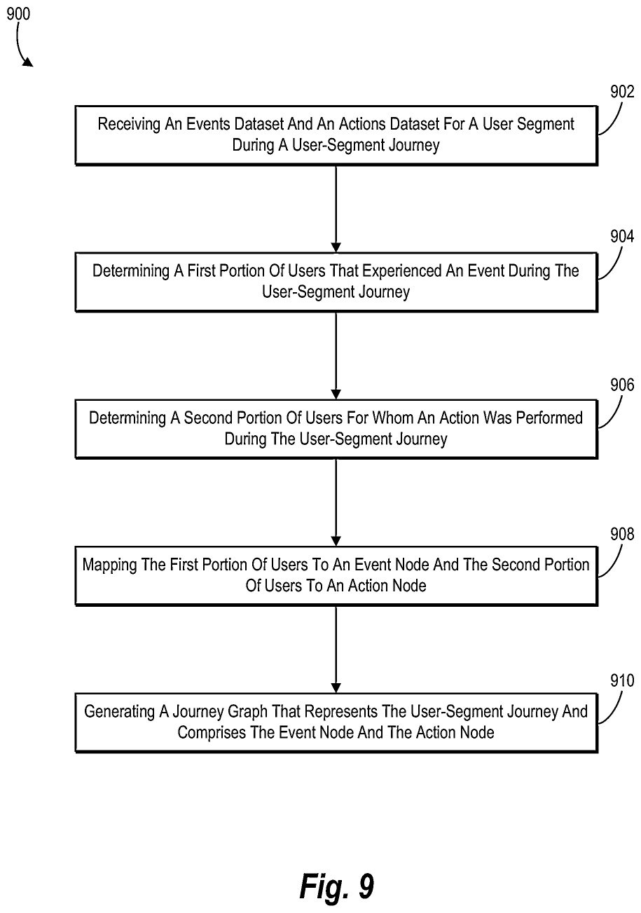

FIGS. 1-8, the corresponding text, and the examples provide a number of different methods, systems, devices, and non-transitory computer-readable media of the journey graphing system 106. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating a journey graph in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 for receiving an events dataset and an actions dataset for a user segment during a user-segment journey. In particular, the act 902 can include receiving an events dataset representing a set of events experienced by users from a user segment during a user-segment journey and an actions dataset representing a set of actions performed for the users from the user segment during the user-segment journey.

As shown in FIG. 9, the series of acts 900 includes an act 904 for determining a first portion of users that experienced an event during the user-segment journey. In particular, the act 904 can include determining a first portion of users from the user segment that experienced an event from the set of events during the user-segment journey. Specifically, the act 904 can include determining that the first portion of users experienced the event during a first part of the user-segment journey.

Additionally, in one or more embodiments, the act 904 includes receiving an updated events dataset representing the set of events or an updated actions dataset representing the set of actions, determining an updated first portion of users that experienced the event or an updated second portion of users for whom the action was performed, and based on determining the updated first portion of users or the updated second portion of users, updating the first visual indicator for the event node to report that the updated first portion of users experienced the event; or updating the second visual indicator for the action node to report that the action was performed for the updated second portion of users. Further, in one or more embodiments, the act 904 includes determining a first value change reflecting a difference between the first portion of users and the updated first portion of users or a second value change reflecting a difference between the second portion of users and the updated second portion of users, and updating the first visual indicator for the event node to reflect the first value change, or updating the second visual indicator for the action node to reflect the second value change.

As shown in FIG. 9, the series of acts 900 includes an act 906 for determining a second portion of users for whom an action was performed during the user-segment journey. In particular, the act 906 can include determining a second portion of users from the user segment for whom an action was performed from the set of actions during the user-segment journey. Specifically, the act 906 can include determine that the action was performed for the second portion of users during a second part of the user-segment journey. Additionally, in one or more embodiments, the act 906 includes determining sub-segments of users having different user characteristics among the first portion of users and generating the journey graph by generating the action node comprising graphical indicators for the sub-segments of users having the different user characteristics among the first portion of users.

As shown in FIG. 9, the series of acts 900 includes an act 908 for mapping the first portion of users to an event node and the second portion of users to an action node. In particular, the act 908 can include mapping the first portion of users to an event node representing the event and the second portion of the users to an action node representing the action.

As shown in FIG. 9, the series of acts 900 includes an act 910 for generating a journey graph that represents the user-segment journey and comprises the event node and the action node. In particular, the act 910 can include generating, for display on a client device, a journey graph that represents the user-segment journey and comprises the event node with a first visual indicator reporting that the first portion of users experienced the event and the action node with a second visual indicator reporting that the action was performed for the second portion of users. Specifically, the act 910 can include generating at least a first edge for the first part of the user-segment journey connecting to the event node comprising a first visual indicator reporting that the first portion of users experienced the event; and generating at least a second edge for the second part of the user-segment journey connecting to the action node comprising a second visual indicator reporting that the action was performed for the second portion of users.

Further, in one or more embodiments, the act 910 includes determining that the first portion of users experienced the event during a first part of the user-segment journey, and determining that the action was performed for the second portion of users during a second part of the user-segment journey. Additionally, the act 910 can include receiving, from the client device, an indication of a user selection of a reporting option to graphically depict the user-segment journey with dynamic reporting features and based on the user selection of the reporting option, provide the journey graph for display on the client device.

Also, in one or more embodiments, the act 910 can include generating the journey graph by generating the first edge with a first edge thickness corresponding to the first portion of users, and generating the second edge with a second edge thickness corresponding to the second portion of users. In some embodiments, the act 910 further includes determining the first portion of users that experienced the event by determining a percentage of users from the user segment that experienced the event after experiencing a preceding event or after having a preceding action performed for the percentage of users, and generating the journey graph by generating the first visual indicator to represent the percentage of users that experienced the event from among users represented by a preceding node for the preceding event or for the preceding action. Additionally, the act 910 can include determining the second portion of users from whom the action was performed by determining a percentage of users from the user segment for whom the action was performed after experiencing a preceding event or after having a preceding action performed for the percentage of users, and generating the journey graph by generating the second visual indicator to represent the percentage of users for whom the action was performed from among users represented by a preceding node for the preceding event or for the preceding action.

Further, in one or more embodiments, the act 910 includes determining a first time elapsed between a preceding event or a preceding action and the event experienced by a first sub-segment from the first port of users, determining a second time elapsed between the preceding event or the preceding action and the event experienced by a second sub-segment from the first port of users, and generating a first graphical indicator representing the first sub-segment corresponding to the first time elapsed and a second graphical indicator representing the second sub-segment corresponding to the second time elapsed. Additionally, in one or more embodiments, the act 910 includes wherein the event node comprises a graphical indication of an event type for the event and the action node comprises a graphical indication of an action type for the action.

In some embodiments, the act 910 also includes determining sub-segments of users from the first portion of users that performed different actions in response to the event experienced by the first portion of users, and generating the journey graph by generating, for the event node, graphical indicators representing the sub-segments of users that performed the different users actions. Further, the act 910 can include determining sub-segments of users from the second portion of users that performed different actions in response to the action performed for the second portion of users, and generating the journey graph by generating, for the action node, graphical indicators representing the sub-segments of users that performed the different users actions.

The act 910 can also include receiving an updated events dataset representing the set of events, determine an updated first portion of users that experienced the event, and based on determining the updated first portion of users that experienced the event: updating the first visual indicator for the event node to report that the updated first portion of users experienced the event, and updating an edge thickness of the at least first edge to indicate the updated first portion of users experienced the event. Additionally, in one or more embodiments, the acts 910 includes receiving an updated actions dataset representing the set of actions, determining an updated second portion of users for whom the action was performed, and based on determining the updated second portion of users from whom the action was performed: updating the second visual indicator for the action node to report that the action was performed for the updated second portion of users, and updating an edge thickness of the at least second edge to indicate the updated second portion of users experienced the event. Further, the act 910 can include determining sub-segments of users having different user characteristics among the second portion of the users and generating the journey graph by generating the event node comprising graphical indicators representing the sub-segments of users having the different user characteristics among the second portion of users.

In some embodiments, the series of acts 900 can also include receiving a condition dataset representing users tracked with respect to a journey-entry condition, determining a portion of users from the user segment satisfying the journey-entry condition to enter the user-segment journey, mapping the portion of users to a condition node representing the journey-entry condition, and generating the journey graph further comprising the condition node with a third visual indicator reporting that the portion of users satisfy the journey-entry condition. Additionally, the series of acts 900 includes receiving an updated dataset representing the set of events experienced by an updated subset of users from the user segment during the user-segment journey, determining an updated subset of users from the user segment that experienced a subset of events, and based on determining the updated subset of users that experiences the subset of events, modify a subset of nodes within the journey graph to indicate the updated subset of users that experienced the subset of events.

In addition to the foregoing, the series of acts 900 can also include performing a step for constructing a journey graph representing the user-segment journey comprising nodes indicating portions of users from the user segment that experienced particular events or particular actions. For instance, the algorithms and acts described in relation to FIG. 5 can comprise the corresponding acts or algorithms corresponding to performing a step for constructing a journey graph representing the user-segment journey comprising nodes indicating portions of users from the user segment that experienced particular events or particular actions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an example computing device 1000 (e.g., the computing device 1000, the client device 108, and/or the server(s) 104) that may be configured to perform one or more of the processes described above. One will appreciate that the causality-visualization system 102 can comprise implementations of the computing device 1000. As shown by FIG. 10, the computing device can comprise a processor 1002, memory 1004, a storage device 1006, an I/O interface 1008, and a communication interface 1010. Furthermore, the computing device 1000 can include an input device such as a touchscreen, mouse, keyboard, etc. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, storage device 1006 can comprise a non-transitory storage medium described above. The storage device 1006 may include a hard disk drive (HDD), flash memory, a Universal Serial Bus (USB) drive or a combination of these or other storage devices.

The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008. The touch screen may be activated with a writing device or a finger.

The I/O devices/interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices 1000 or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause a computing device to:
receive an events dataset representing a set of events experienced by users from a user segment during a user-segment journey and an actions dataset representing a set of actions performed for the users from the user segment during the user-segment journey;
determine a first portion of users from the user segment that experienced an event from the set of events during the user-segment journey;
determine a second portion of users from the user segment for whom an action was performed from the set of actions during the user-segment journey;
map the first portion of users to an event node representing the event and the second portion of the users to an action node representing the action; and
generate, for display on a client device, a journey graph that represents the user-segment journey and comprises the event node with a first visual indicator reporting that the first portion of users experienced the event and the action node with a second visual indicator reporting that the action was performed for the second portion of users.

2. The non-transitory computer-readable medium of claim 1, further comprising instructions that, when executed by the at least one processor, further cause the computing device to:
determine that the first portion of users experienced the event during a first part of the user-segment journey;
determine that the action was performed for the second portion of users during a second part of the user-segment journey;
generate the journey graph by:
generating at least a first edge for the first part of the user-segment journey connecting to the event node; and
generating at least a second edge for the second part of the user-segment journey connecting to the action node.

3. The non-transitory computer-readable medium of claim 1, further comprising instructions that, when executed by the at least one processor, further cause the computing device to:
receive, from the client device, an indication of a user selection of a reporting option to graphically depict the user-segment journey with dynamic reporting features; and
based on the user selection of the reporting option, provide the journey graph for display on the client device.

4. The non-transitory computer-readable medium of claim 1, further comprising instructions that, when executed by the at least one processor, further cause the computing device to:
receive an updated events dataset representing the set of events or an updated actions dataset representing the set of actions;
determine an updated first portion of users that experienced the event or an updated second portion of users for whom the action was performed; and
based on determining the updated first portion of users or the updated second portion of users;
update the first visual indicator for the event node to report that the updated first portion of users experienced the event; or
update the second visual indicator for the action node to report that the action was performed for the updated second portion of users.

5. The non-transitory computer-readable medium of claim 4, further comprising instructions that, when executed by the at least one processor, further cause the computing device to:
determine a first value change reflecting a difference between the first portion of users and the updated first portion of users or a second value change reflecting a difference between the second portion of users and the updated second portion of users; and
update the first visual indicator for the event node to reflect the first value change; or
update the second visual indicator for the action node to reflect the second value change.

6. The non-transitory computer-readable medium of claim 1, further comprising instructions that, when executed by the at least one processor, further cause the computing device to:
determine sub-segments of users having different user characteristics among the first portion of users; and
generate the journey graph by generating the action node comprising graphical indicators for the sub-segments of users having the different user characteristics among the first portion of users.

7. The non-transitory computer-readable medium of claim 1, further comprising instructions that, when executed by the at least one processor, further cause the computing device to:
determine sub-segments of users having different user characteristics among the second portion of the users; and
generate the journey graph by generating the event node comprising graphical indicators representing the sub-segments of users having the different user characteristics among the second portion of users.

8. A system comprising:
one or more memory devices comprising an events dataset representing a set of events experienced by users from a user segment during a user-segment journey and an actions dataset representing a set of actions performed for the users from the user segment during the user-segment journey; and
one or more computing devices that are configured to cause the system to:
determine a first portion of users from the user segment that experienced an event from the set of events during a first part of the user-segment journey;
determine a second portion of users from the user segment for whom an action was performed from the set of actions during a second part of the user-segment journey;
map the first portion of users to an event node representing the event and the second portion of the users to an action node representing the action; and
generate, for display on a client device, a journey graph representing the user-segment journey by:
generating at least a first edge for the first part of the user-segment journey connecting to the event node comprising a first visual indicator reporting that the first portion of users experienced the event; and
generating at least a second edge for the second part of the user-segment journey connecting to the action node comprising a second visual indicator reporting that the action was performed for the second portion of users.

9. The system of claim 8, further comprising instructions that, when executed by the one or more computing devices, further cause the system to generate the journey graph by:
generating the first edge with a first edge thickness corresponding to the first portion of users; and
generating the second edge with a second edge thickness corresponding to the second portion of users.

10. The system of claim 8, further comprising instructions that, when executed by the one or more computing devices, further cause the system to:
determine the first portion of users that experienced the event by determining a percentage of users from the user segment that experienced the event after experiencing a preceding event or after having a preceding action performed for the percentage of users; and
generate the journey graph by generating the first visual indicator to represent the percentage of users that experienced the event from among users represented by a preceding node for the preceding event or for the preceding action.

11. The system of claim 8, further comprising instructions that, when executed by the one or more computing devices, further cause the system to:
determine the second portion of users from whom the action was performed by determining a percentage of users from the user segment for whom the action was performed after experiencing a preceding event or after having a preceding action performed for the percentage of users; and
generate the journey graph by generating the second visual indicator to represent the percentage of users for whom the action was performed from among users represented by a preceding node for the preceding event or for the preceding action.

12. The system of claim 8, further comprising instructions that, when executed by the one or more computing devices, further cause the system to:
determine a first time elapsed between a preceding event or a preceding action and the event experienced by a first sub-segment from the first port of users;
determine a second time elapsed between the preceding event or the preceding action and the event experienced by a second sub-segment from the first port of users; and
generate a first graphical indicator representing the first sub-segment corresponding to the first time elapsed and a second graphical indicator representing the second sub-segment corresponding to the second time elapsed.

13. The system of claim 8, wherein the event node comprises a graphical indication of an event type for the event and the action node comprises a graphical indication of an action type for the action.

14. The system of claim 8, further comprising instructions that, when executed by the one or more computing devices, further cause the system to:
receive an updated events dataset representing the set of events;
determine an updated first portion of users that experienced the event; and
based on determining the updated first portion of users that experienced the event:
update the first visual indicator for the event node to report that the updated first portion of users experienced the event; and
update an edge thickness of the at least first edge to indicate the updated first portion of users experienced the event.

15. The system of claim 8, further comprising instructions that, when executed by the one or more computing devices, further cause the system to:
receive an updated actions dataset representing the set of actions;
determine an updated second portion of users for whom the action was performed; and
based on determining the updated second portion of users from whom the action was performed:
update the second visual indicator for the action node to report that the action was performed for the updated second portion of users; and
update an edge thickness of the at least second edge to indicate the updated second portion of users experienced the event.

16. The system of claim 8, further comprising instructions that, when executed by the one or more computing devices, further cause the system to:
receive a condition dataset representing users tracked with respect to a journey-entry condition;
determine a portion of users from the user segment satisfying the journey-entry condition to enter the user-segment journey;
map the portion of users to a condition node representing the journey-entry condition; and
generate the journey graph further comprising the condition node with a third visual indicator reporting that the portion of users satisfy the journey-entry condition.

17. The system of claim 8, further comprising instructions that, when executed by the one or more computing devices, further cause the system to:
determine sub-segments of users from the first portion of users that performed different actions in response to the event experienced by the first portion of users; and
generate the journey graph by generating, for the event node, graphical indicators representing sub-segments of users that performed the different users actions.

18. The system of claim 8, further comprising instructions that, when executed by the one or more computing devices, further cause the system to:
determine sub-segments of users from the second portion of users that performed different actions in response to the action performed for the second portion of users; and
generate the journey graph by generating, for the action node, graphical indicators representing sub-segments of users that performed the different users actions.

19. A method comprising:
receiving, from a client device, an indication of a user selection of a reporting option to graphically depict a user-segment journey with dynamic reporting features;
receiving a dataset representing a set of events experienced by users from a user segment and a set of actions performed for the users from the user segment during a user-segment journey;
performing a step for constructing a journey graph representing the user-segment journey comprising nodes indicating portions of users from the user segment that experienced particular events or particular actions; and
based on the user selection of the reporting option, providing the journey graph for display on the client device.

20. The method of claim 19, further comprising:
receiving an updated dataset representing the set of events experienced by an updated subset of users from the user segment during the user-segment journey;
determining an updated subset of users from the user segment that experienced a subset of events; and
based on determining the updated subset of users that experiences the subset of events, modify a subset of nodes within the journey graph to indicate the updated subset of users that experienced the subset of events.
